(19) United States
(12) Patent Application Publication
(10) Pub. No.: US 2019/0061047 A1
(43) Pub. Date: Feb. 28, 2019

(54) LINEAR FRICTION WELDING

(71) Applicant: Kuka Systems UK Limited, Halesowen (GB)

(72) Inventors: Stephen Reed, Staffordshire (GB); Frederick John Harris, Solihull (GB); John Searle, Staffordshire (GB)

(21) Appl. No.: 16/162,605

(22) Filed: Oct. 17, 2018

Related U.S. Application Data
(62) Division of application No. 14/774,738, filed on Sep. 11, 2015, now abandoned.

(30) Foreign Application Priority Data
Mar. 11, 2013 (GB) 1304331.0

(51) Int. Cl. B23K 20/12

(52) U.S. Cl. CPC B23K 20/1245; B23K 20/1205

(57) ABSTRACT

A method and apparatus for friction welding. The method includes frictionally engaging a weld surface of a first workpiece and a weld surface of a second workpiece; oscillating the weld surface of the first workpiece and the second workpiece until they reach a fusion point, and applying a forge force to the first workpiece with the second workpiece, so that the workpieces are urged into contact at a weld point, wherein the weld point is the centroid of an interface between the weld surfaces.

### CROSS REFERENCE TO RELATED APPLICATIONS

This is a division patent application of co-pending U.S. patent application Ser. No. 14/774,738, filed Sep. 11, 2015, which claims priority to International Patent Application No. PCT:GB14/050723 filed Mar. 11, 2014, which claims the benefit of GB1304331.0 filed Mar. 11, 2013. The contents of these prior applications are incorporated herein by reference.

### BACKGROUND OF THE INVENTION

The present invention relates to methods and apparatus for friction welding.

Friction welding is used in engineering fields as a means for joining two bodies together without the requirement for a solder, flux or filler material. The technique offers certain advantages over traditional welding methods, as its relatively melt-free nature prevents grain growth in high engineered materials. Moreover, the rippled sheets of the material created around the weld join and known as “flash”, carry debris and dirt away from the joint, negating the requirement to perform significant pre-treatment of the join surfaces.

Furthermore, friction welding can be used to join two materials of very different melting points, such as aluminium and steel, which would not be possible using traditional welding methods. This is particularly useful in the aerospace industry where the additional weight of, say, bolts or rivets that may otherwise be required to ensure adequate join strengths, is undesirable.

Spin welding, or rotational friction welding is when one of the two bodies to be joined is rotated at high speed and then held under pressure against the other body.

The join is usually set by keeping the join under pressure after the rotation has finished.

Linear friction welding, on the other hand, is performed when one or both of the bodies to be joined is linearly oscillated with respect to the other. A forge force is applied to the bodies, typically to the stationary body during and after oscillation to effect the join.

In prior art linear friction welding techniques, the forge force which can be applied to the bodies is limited to around 100 tonnes depending upon material, as larger forces tend to make alignment of the bodies unreliable.

Moreover, these known techniques make it possible to weld only two bodies together at the same time.

### BRIEF DESCRIPTION OF THE INVENTION

It is an object of the present invention to overcome at least some of the disadvantages of the prior art.

Accordingly, it is an object of the present invention to provide an apparatus for linear friction welding which enables the application of a forge force of more than 100 tonnes, typically up to around 500 tonnes depending upon material.

Moreover, it is a further object of the invention to provide an apparatus for linear friction welding which enables the simultaneous welding of more than two bodies.

According to a first aspect of the present invention there is provided an apparatus for friction welding, the apparatus comprising:
a mounting plate having a surface for mounting a first workpiece;
a forge for applying a forge force to a second workpiece in a direction substantially perpendicular to the surface of the mounting plate;
an oscillator for effecting oscillation of the mounting plate in a direction substantially perpendicular to the direction of the forge force.

Preferably the apparatus includes a first line drawn from the centre of mass of the oscillator parallel to the direction of oscillation intersects a second line parallel to the direction of the forge force at a weld point between the mounting plate and the forge.

The inventors have found that by arranging the apparatus around the position of the weld point, that is the centroid of the area being welded at the time of the finished weld, thereby ensuring that no rotational moment acts thereupon, far greater forge forces can be exerted on the weld, affording quicker and stronger joins between articles.

Preferably, the forge is arranged to exert the forge force on a second workpiece such that no rotational movement, e.g. no rotational moment about the centroid of the weld area, is applied in use.

In one embodiment, the forge force is applied so that no rotational movement occurs about the centroid of the weld area.

Preferably, the average vector of the forge force intersects the weld point and is substantially perpendicular to the plane of the weld area.

Preferably, the forge comprises at least one forge cylinder for exerting the forge force. Preferably the forge comprises two forge cylinders, which may be positioned to exert, in use, force equidistantly either side of the weld point.

Preferably, forge forces are balanced, e.g. the oscillator, forge axis and forge cylinders act on substantially the centre of the weld.

Preferably, the weld may comprise a single part or a multiple part weld.

Preferably, the apparatus comprises side plates substantially perpendicular to and either side of the mounting plate, e.g. to provide a weld housing.

Preferably, the apparatus comprises at least one locking device for locking the forge to the side plates.

Preferably the forge is movable towards and away from the mounting plate, e.g. to allow positioning of workpieces at the mounting plate.

Preferably the mounting plate is arranged to position a weld face of a first workpiece at the weld point. Preferably the mounting plate is movable and/or adjustable to position the weld face, e.g. the centroid of a weld area, of a first workpiece at the weld point.

In a further aspect, the invention provides a method for friction welding e.g. linear friction welding comprising:
frictionally engaging a weld surface of a first workpiece and a weld surface of a second workpiece;
applying a forge force to the first workpiece and/or the second workpiece such that the rotational moment about a weld point is zero, wherein the weld point is the centroid of the interface between the weld surfaces.

In a further aspect of the present invention there is provided a method for friction welding, the method comprising:
frictionally engaging a weld surface of a first workpiece and a weld surface of a second workpiece;
oscillating the weld surface of the first workpiece and the second workpiece until they reach a fusion point; and
applying a forge force to the first workpiece with the second workpiece, so that the workpieces are urged into contact at a weld point, wherein the weld point is the centroid of the interface between the weld surfaces.

Preferably, the method comprises frictionally engaging the weld surface of the first workpieces with weld surfaces of two or more second workpieces.

Preferably, the forge force applied to the first workpiece and/or the two or more second workpieces provides a rotational moment about the weld point of zero, wherein the weld point is centroid of the total interfaces of the weld surfaces.

Preferably the first and/or the second workpiece is oscillated at from 10 to 100 oscillations per second, e.g. at least 25-45 oscillations per second in a direction substantially perpendicular to the weld forces of the first and second workpieces.

Preferably, the neither of the first and/or second weld pieces is oscillated while the forge force is applied.

Preferably the forge force has a magnitude of between 4 tonnes and 150 tonnes, e.g. between 80 tonnes and 120 tonnes.

Preferably the forge force has a magnitude of at least 65 tonnes, e.g. at least 80 tonnes.

Preferably the oscillation of the first and/or second workpieces is effected by an oscillator.

Preferably, the first and second workpieces are positioned such that, in use, the centre of mass of the oscillator is coplanar with the weld faces.

Preferably the first and second workpieces are positioned such that the or a centroid of the interface between the first and second weld faces is aligned with the centre of mass of the oscillator.

Preferably the method comprises allowing the first and second workpieces to cool before releasing the forge force.

### BRIEF DESCRIPTION OF THE DRAWINGS

Embodiments of the present invention will now be described with reference to the following drawings.

FIG. 1 shows a friction welding apparatus in a profile view;

FIG. 2 shows a friction welding apparatus in plan view;

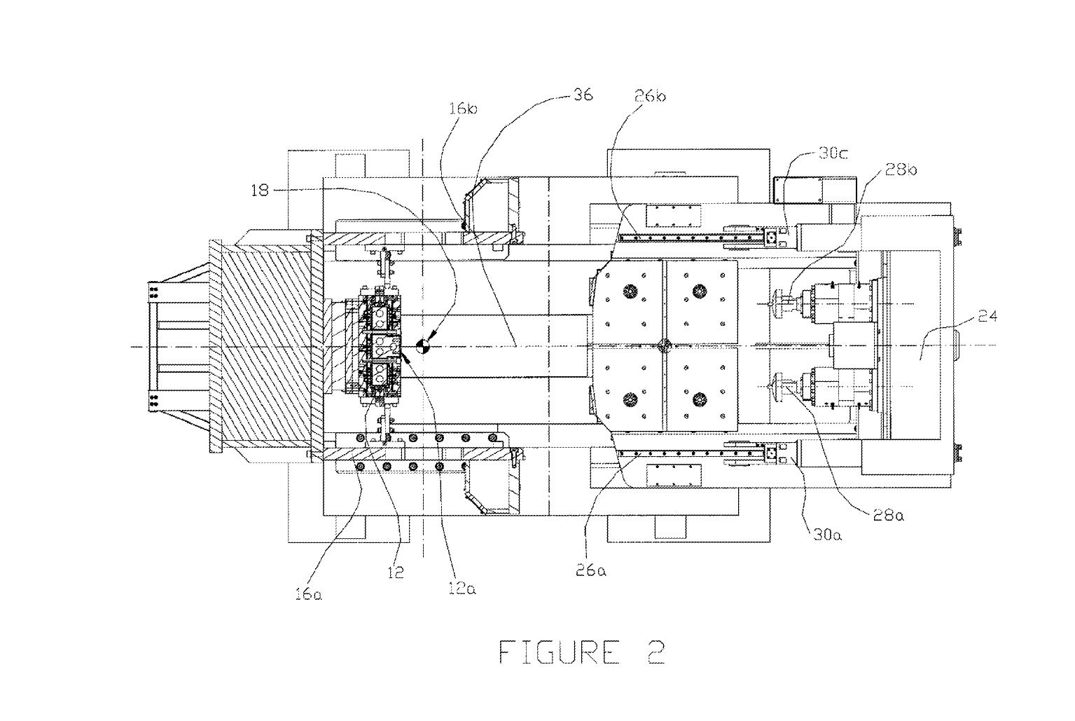

FIG. 3 shows a friction welding apparatus in perspective view;

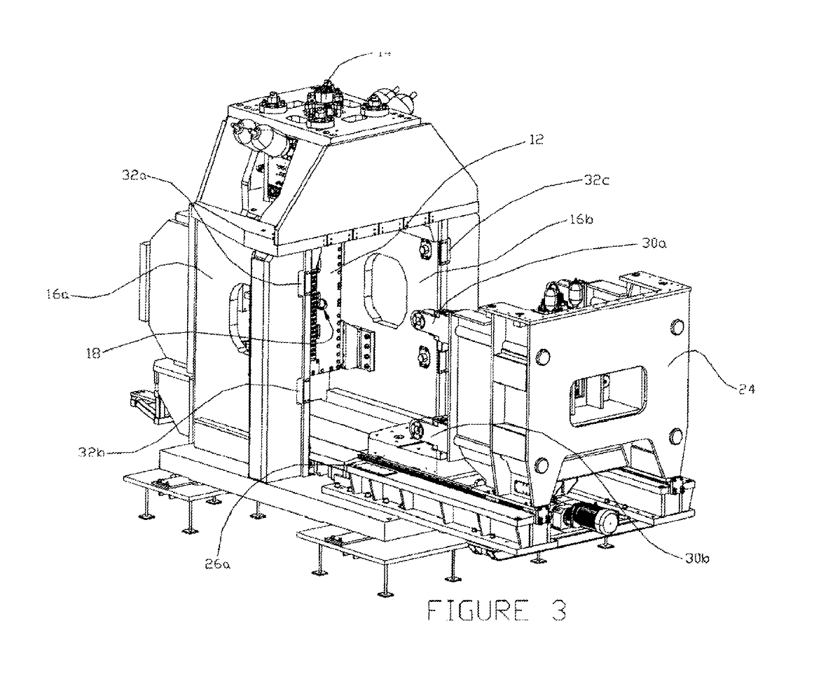

FIG. 4 shows a perspective view of a friction welding apparatus showing the directions of oscillation and direction of movement of the forge;

FIG. 5 shows a graph of displacements and forces against time in performing a typical weld.

### DETAILED DESCRIPTION OF THE INVENTION

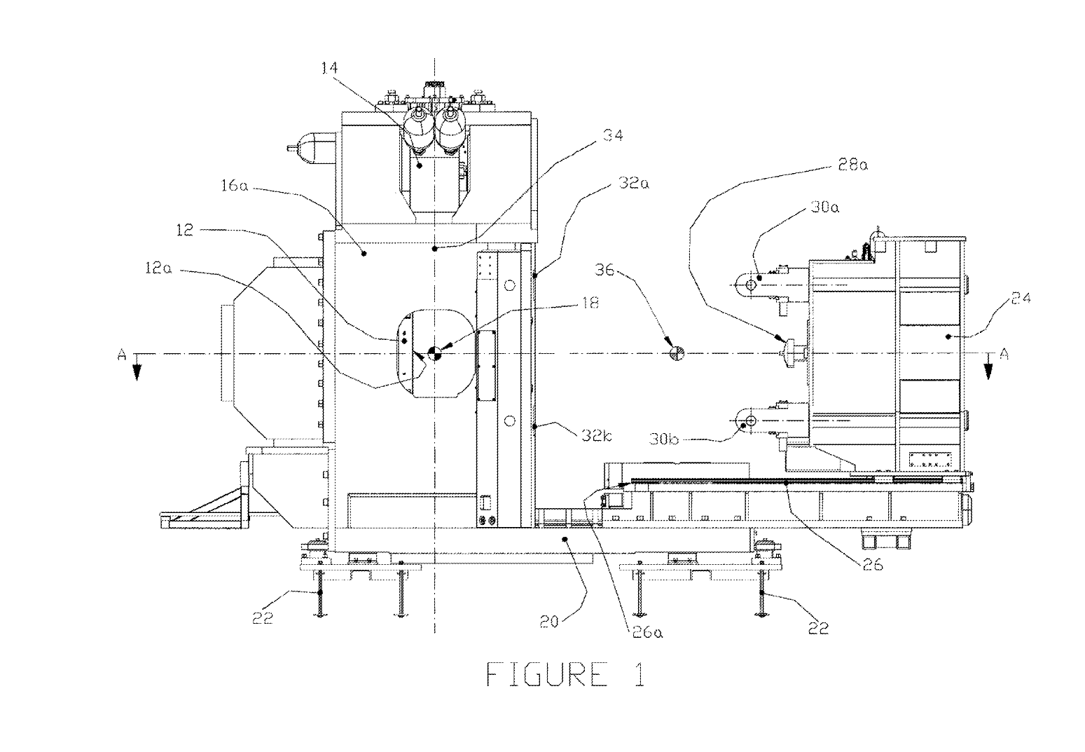

FIG. 1 shows a linear friction welding apparatus 10. The apparatus 10 comprises a mounting plate 12 for mounting a first workpiece thereon. The mounting plate 12 is held vertically by and below an oscillator 14 and between a pair of parallel side plates 16a, 16b.

The oscillator 14 is fixed atop the side plates 16a, 16b such that it rests above the gap therebetween.

The side plates 16a, 16b are mounted upon a chassis 20 which may be fixed to the floor by fixings 22. Also mounted on the chassis 20 is a forge 24 by means of rails 26 which are substantially perpendicular to the face 12a of the mounting plate 12. The forge 24 is movable along the rails 26 towards the mounting plate 12. The forge 24 comprises a pair of forge cylinders 28a, 28b extending from the forge 24 toward the mounting plate 12 through which the forge force is applied

Four male locking members 30a, 30b, 30c, 30d extend from the corners of the forge 24 towards the side plates 16a, 16b. Corresponding lock recesses 32a, 32b, 32c, 32d in the side plates 16a, 16b are formed to receive the male locking members 30a, 30b, 30c, 30d when the forge 24 is positioned at the forward extremity 26a of the rails 26.

The positioning of the contingent parts of the apparatus 10 contributes to the improved operation in use during friction welding.

The oscillator 14 is positioned such that its centre of mass lies on a vertical line 34 midway between the side plates 16a, 16b and between the mounting plate 12 and the forge 24.

The position of the mounting plate 12 relative to the vertical line 34 is adjustable via adjustment means (not shown).

This vertical line 34 is intersected at a weld point 18 by a horizontal line 36 which can be drawn from the forge 24 at a point equidistant between the two forge cylinders 28a, 28b, the horizontal line 36 being parallel to the rails 26.

The weld point 18 represents the centroid of the weld interface area when the workpieces are at the finished weld position. The mounting plate 12 allows for the positioning of workpieces accordingly.

In this specific embodiment, the positioning of the locking members 30a, 30b, 30c, 30d is also regular with respect to the weld point. In particular, where the locking members are aligned vertically (i.e. the member 30a above the member 30b and the member 30c above the member 30d) they are arranged such that the centreline of each is an equal distance in the vertical plane and an equal distance in the horizontal plane from the horizontal line 36.

The increased stability afforded to the machine by some or all of these arrangements permits a large forge force to be used during welding.

In a first method of friction welding utilising the above apparatus, a first workpiece is attached to the mounting plate 12 such that the centroid of its intended weld area is positioned at the weld point 18.

A second workpiece is attached to the forge 24, and is clamped such that the centroid of the intended weld area is positioned can be brought to bear against the first workpiece at the weld point 18.

The forge 24 is then moved to its forward position along rails 26 and the locking members 30a, 30b, 30c, 30d are engaged and locked in the corresponding recesses 32a, 32b, 32c, 32d, thereby bringing the workpieces to bear against each other.

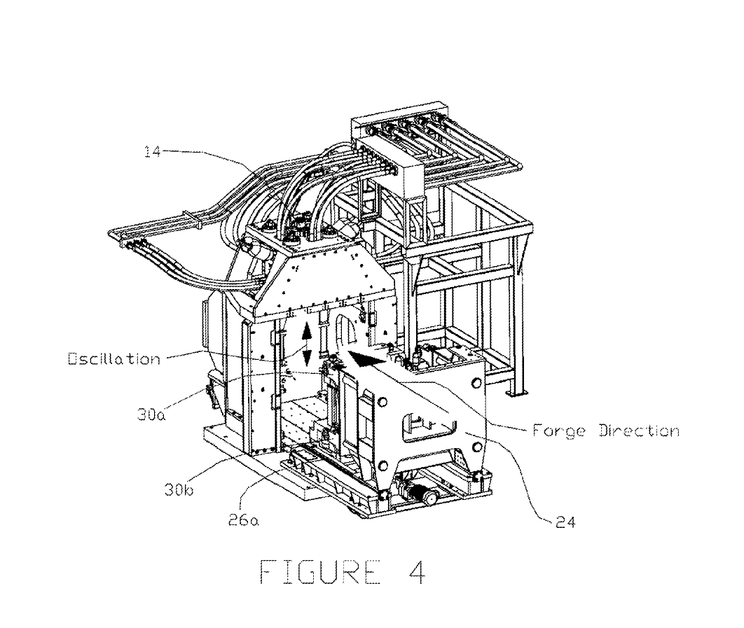

FIG. 4 shows a perspective view of the welding apparatus and shows the direction of oscillation of the first workpiece mounted in mounting plate 12. The oscillation generated by oscillator 14 is in a vertical plane parallel to line 34.

FIG. 4 also shows the direction of movement of the forge 24 moving along rails 26 to bring the workpieces into contact in the region of the mounting plate 12 and ideally at weld point 18.

The oscillator 14 is then activated to effect frictional movement between the workpieces in the vertical plane along the line 34. The oscillator 14 preferably oscillates the mounting plate 12 at a frequency of 10-100 oscillations per second, more preferably at least 25-45 oscillations per second.

The workpieces are brought into contact as described above. The forge forces applied in the early phase, as the workpieces are brought into contact, are relatively small and typically of the order of 230 kN. The forces applied to the workpieces by the forge are sufficient to generate friction which heats the workpieces in the region of the weld point 18.

The heating causes the workpieces to soften and when the regions around the weld point 18 are sufficiently hot, soft and plastically deformable they can be considered to have reached a fusion point, as understood by a person skilled in the art. At the fusion point the oscillator 14 is deactivated and the mounting plate re-aligned such that the workpieces are in there are in their intended final position

The forge 24 is then activated such that the forge cylinders 28a, 28b apply a much higher forge force of up to around 500 tonnes to the second workpiece, thereby forcing the two workpieces together. Once the workpieces have cooled and hardened, the forge force is removed and the workpieces, now joined, are removed from the apparatus 10.

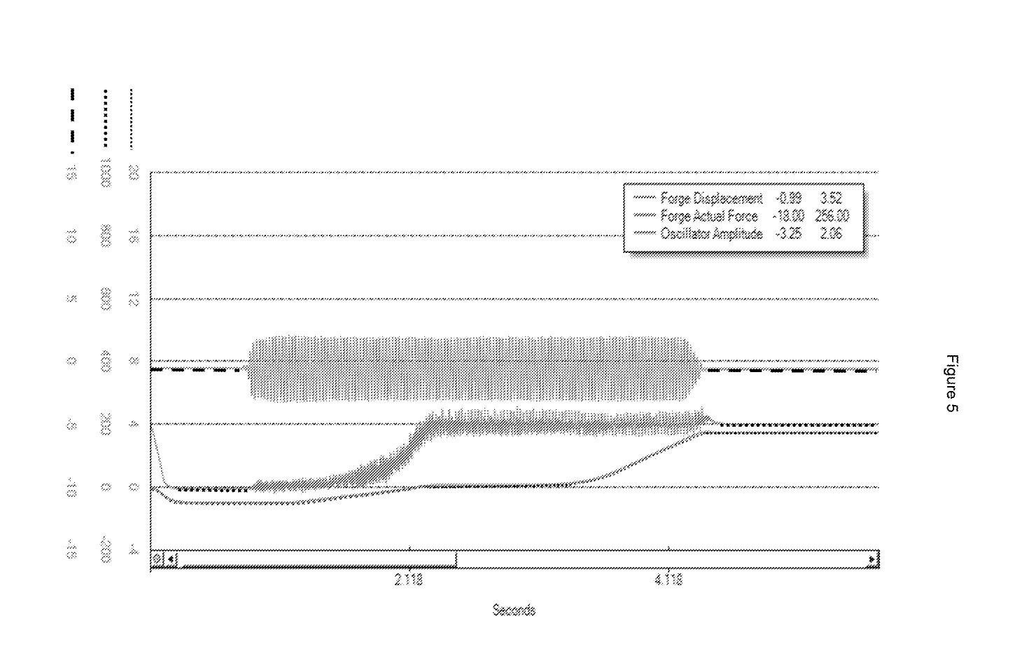

FIG. 5 shows a typical weld profile, showing the relationship between forge displacement, the actual forge force and oscillator amplitude.

This is shown as a displacement against time, from which it can be seen the time to make a weld is ordinarily a matter of a few seconds.

As explained above, the oscillator 14 is achieved and displaced by only a small amount on either side of a neutral or zero displacement point, typically ±2.5 mm.

During the early phase of the weld, the pressure applied by the forge is relatively low but sufficient to generate frictional heating. At the point when the materials becomes sufficiently and appropriately soft and are plastically deformable or approaching a fusion point, when the materials will fuse together, the oscillator 14 is stopped and the clamping pressure significantly increased to force the two workpieces together at the weld point 18.

It will be appreciated that the fusion point, at which two workpieces can be fused together will depend upon the nature of the workpiece materials. Clearly the temperatures and amount of plastic deformation needed will vary according to the composition of the particular metals or alloys being welded.

In a second mode of operation, the apparatus is configured to join more than one workpiece (e.g. a second workpiece and a third workpiece, etc.) to a first workpiece.

In performing this multiple weld operation, the first workpiece is attached to the mounting plate as described above.

The second and third workpieces are then mounted onto the forge, again in the same manner as described above, such that the first workpiece and the second and third workpieces are aligned as is intended in the finished weld.

For an optimum weld finish, it is preferable to ensure that the centroid of the combined weld areas lies at the weld point 18.

As the skilled person understands, this means that there need not necessarily be any contact between the first workpieces and the second and third workpieces at the weld point 18.

Once the workpieces are correctly positioned, the forge 34 is locked to the sideplates 16a, 16b, the second and third workpieces are brought to bear against the first workpiece and the oscillator 14 is activated, as described above.

The oscillator 14 is deactivated when the workpieces have reached their fusion point, at which time a forge force is applied by the forge cylinders 28a, 28b. Once the workpieces have cooled, the forge force is removed and the finished, welded piece is removed from the apparatus 10.

No doubt many other effective alternatives will occur to the skilled person. It will be understood that the invention is not limited to the described embodiments and encompasses modifications apparent to those skilled in the art lying within the spirit and scope of the claims appended hereto.

Whilst it is convenient to design and assemble the welding apparatus as shown with the oscillators 14 mounted above the machine and mounting plate 12, resulting in a vertical operation and oscillation of the mounting plate 12, it is also possible and practical to mount the oscillators to provide a horizontal operation. Indeed, the horizontal operation could entail the positioning of an oscillator on either side of a horizontal axis in which includes the mounting plate such arrangement can be shown to have some benefits in terms of configuration of the oscillators, their size and the position of other associated companies.

1. A method for friction welding, the method comprising:
frictionally engaging a weld surface of a first workpiece and a weld surface of a second workpiece;
oscillating the weld surface of the first workpiece and the second workpiece until they reach a fusion point; and
applying a forge force to the first workpiece with the second workpiece, so that the workpieces are urged into contact at a weld point, wherein the weld point is the centroid of an interface between the weld surfaces.

2. The method as claimed in claim 1, wherein the first and/or the second workpiece is oscillated in a direction substantially perpendicular to the weld forces of the first and second workpieces.

3. The method as claimed in claim 2, wherein the first and/or the second workpiece is oscillated at about 10 to 100 oscillations per second.

4. The method as claimed in claims 2, wherein neither of the first and/or second weld pieces is oscillated while the forge force is applied.

5. The method as claimed in claim 2, wherein the first and second workpieces are positioned such that, in use, the centre of mass of the oscillator is coplanar with the weld surfaces.

6. The method as claimed in claim 5, wherein the first and second workpieces are positioned such that the centroid of the interface between the weld surfaces is aligned with the centre of mass of the oscillator.

7. The method as claimed in claim 1, wherein the method forms a single part weld or a multiple part weld.

8. The method as claimed in claim 1, wherein the method is performed with an apparatus comprising:
a mounting plate having a surface for mounting the first workpiece;
a forge for applying the forge force to the second workpiece in a forge force direction along an axis of the forge and substantially perpendicular to the surface of the mounting plate; and
an oscillator for effecting the oscillation of the mounting plate in a direction of oscillation that is substantially perpendicular to the forge force direction to form multiple welds within an intended weld area of the interface between the weld surfaces of the first and second workpieces.

9. The method as claimed in claim 8, wherein a first line drawn from the centre of mass of the oscillator parallel to the direction of oscillation intersects a second line parallel to the direction of the forge force at the weld point between the mounting plate and the forge.

10. The method as claimed in claim 9, wherein the forge force is applied such that no rotational movement is applied in use.

11. The method as claimed in claim 10, wherein an average vector of the forge force intersects the intended weld area and is substantially perpendicular to a plane of the intended weld area.

12. The method as claimed in claim 9, wherein the forge comprises at least one forge cylinder for exerting the forge force, and the forge comprises two forge cylinders that exert forces equidistantly to either side of the centroid of the interface.

13. The method as claimed in claim 12, wherein the forge force exerted by the at least one forge cylinder and the forces exerted by the two forge cylinders are balanced such that the oscillator and the forge provide a force on substantially the centroid of the interface.

14. The method as claimed in claim 8. wherein the apparatus comprises side plates substantially perpendicular to and to either side of the mounting plate so as to provide a weld housing, the apparatus comprises at least one locking device for locking the forge to the side plates, and the forge is moved towards and away from the mounting plate so as to allow positioning of the first and second workpieces at the mounting plate.

15. The method as claimed in claim 14, further comprising moving the mounting plate to position the weld surface of the first workpiece at the weld point.
